(19) United States
(12) Patent Application Publication
(10) Pub. No.: US 2017/0039498 A1
(43) Pub. Date: Feb. 9, 2017

(54) SYSTEMS AND METHODS TO FORECAST AND IMPROVE PRODUCT ON-SHELF AVAILABILITY

(71) Applicant: Wal-Mart Stores, Inc., Bentonville, AR (US)

(72) Inventors: Aaron J. Vasgaard, Rogers, AR (US); Jeffrey S. Cruz, Bentonville, AR (US); Robert J. Taylor, Rogers, AR (US); Sayak S. Majumdar, Rogers, AR (US)

(21) Appl. No.: 15/229,574

(22) Filed: Aug. 5, 2016

Related U.S. Application Data
(60) Provisional application No. 62/201,181, filed on Aug. 5, 2015.

(51) Int. Cl. G06Q 10/06; G06Q 10/04; G06N 5/04

(52) U.S. Cl. CPC G06Q 10/06313; G06N 5/04; G06Q 10/063116; G06Q 10/04

(57) ABSTRACT

Methods, systems and apparatus are provided in predicting an On-Shelf-Availability (OSA) and/or implementing modifications to achieve a desired OSA. Some embodiments provide a system, comprising: A system comprising: an OSA control system comprising a control circuit that executes instructions from a memory to cause the control circuit to: receive a future OSA goal at the multiple shopping facilities; receive predicted workloads corresponding to the defined period of time and predicted to be assigned to the multiple shopping facilities; determine a forecasted OSA as a function of the predicted workloads relative to the planned work force availability at the shopping facilities to complete the work tasks at each of the shopping facilities; and determine whether the forecasted OSA is predicted to be within an OSA threshold of the OSA goal as a function of the predicted workloads relative to planned work force availability at the shopping facilities.

### CROSS-REFERENCE TO RELATED APPLICATION

This application claims the benefit of U.S. Provisional Application No. 62/201,181, filed Aug. 5, 2015, and is incorporated herein by reference in its entirety.

### TECHNICAL FIELD

These teachings relate generally to shopping experiences and more particularly to devices, systems and methods for providing products for purchase.

### BACKGROUND

In a modern retail environment, customers have access to hundreds if not thousands of potential products. The shopping facilities must order and receive large amounts of inventory to provide customers with access to all these products. Still further, the shopping facilities must distribute these products to the sales floor to be available for purchase.

There is a need to improve the customer experience and/or convenience for the customer. There is a further need to improve the efficiency and productivity of a shopping facility and workers at a shopping facility.

### BRIEF DESCRIPTION OF THE DRAWINGS

The above needs are at least partially met through provision of embodiments of systems, devices, and methods designed to manage and/or improve On-Shelf-Availability (OSA) at shopping facilities, such as described in the following detailed description, particularly when studied in conjunction with the drawings, wherein:

FIG. 1 illustrates a simplified block diagram of an OSA forecasting system configured to forecast and provide control over product OSA across multiple shopping facilities, in accordance with some embodiments;

FIG. 2 illustrates a simplified block diagram of an exemplary OSA control system, in accordance with some embodiments;

FIG. 3 illustrates a simplified block diagram of an exemplary task management system, in accordance with some embodiments;

FIG. 4 illustrates a simplified block diagram of an exemplary work force management system, in accordance with some embodiments;

FIG. 5 shows a simplified flow diagram of an exemplary process of forecasting and/or managing OSA, in accordance with some embodiments; and

FIG. 6 illustrates a simplified block diagram of an exemplary regression modeling system in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

It has been determined that the amount of stock available on shelves, racks and other such product supports of product storage units (commonly referred to as On-Shelf-Availability) within shopping facilities and accessible to customers can have a significant effect on sales. Accordingly, it can be advantageous to sales to achieve and/or attempt to maintain a desired On-Shelf-Availability (OSA) in an attempt to improve and/or optimize sales. The desired OSA goal can be determined based on many different criteria, and the criteria often differ for different products and/or shopping facilities.

Maintaining desired OSA levels, however, can be difficult because of many different factors. One of the major factors that can affect OSA is an available work force to perform the tasks needed to be able to restock the shelves, racks, bins, modulars, and the like (generally referred to for simplicity as shelves). Some embodiments forecast the availability of a work force based on forecasted workloads, and based on the forecasted availability of a work force are able to forecast an OSA. The forecasted OSA can further be used to determine whether to implement modifications to workloads (e.g., shifting work allocation), available work force and/or implement other modifications in an effort to achieve a desired or goal OSA. Accordingly, some embodiments forecast the impact of various factors or metrics to OSA and adjust such said factors in an attempt to achieve an OSA goal and/or maximize OSA for one or more shopping facilities (e.g., shopping facilities across a chain).

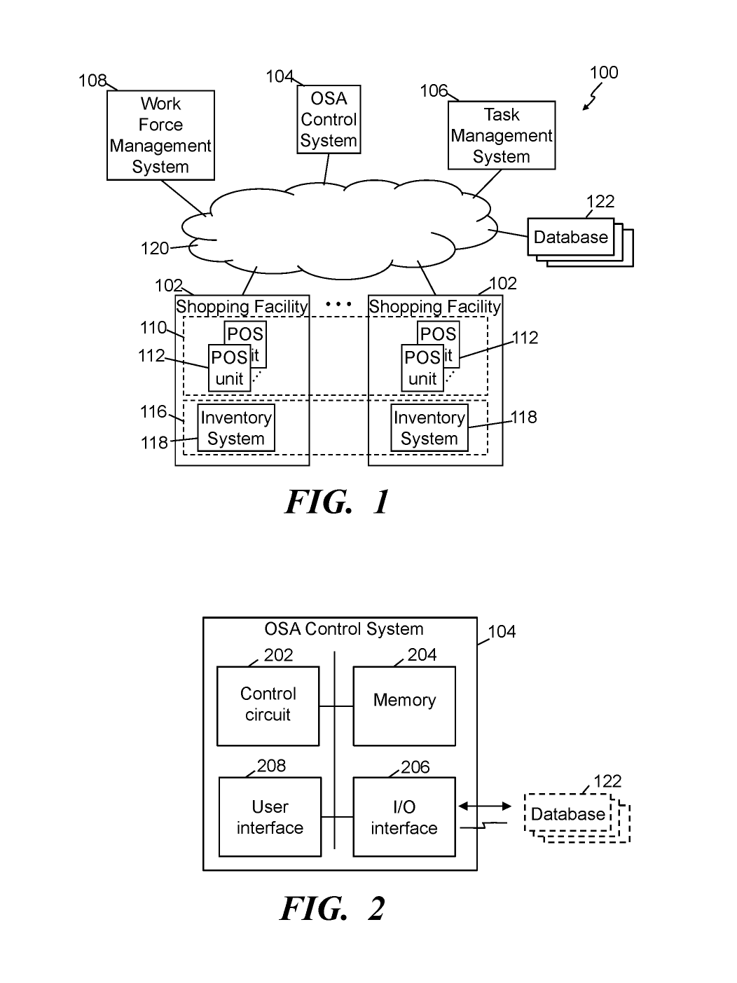

FIG. 1 illustrates a simplified block diagram of an OSA forecasting system 100 configured to forecast and provide control over the OSA for multiple (and typically hundreds or thousands of products) across multiple shopping facilities 102, in accordance with some embodiments. The OSA forecasting system 100 includes one or more OSA control systems 104, one or more task management systems 106, one or more work force management systems 108, one or more point-of-sale systems 110 that include multiple point-of-sale units 112 at the multiple shopping facilities 102, and one or more supply tracking systems 116 that typically include one or more inventory systems 118 of the multiple shopping facilities. In some implementations, the OSA control system 104 is in communication with the task management system 106, the work force management system 108, the point-of-sale system 110, and the supply tracking systems 116 through one or more communication and/or data networks 120, such as the Internet, one or more wide area networks (WAN), one or more local area networks (LAN), one or more cellular communication networks, other such networks, or combinations of two or more of such networks that provide wired, wireless or a combination of wired and wireless communication. FIG. 1 shows the task management system, work force management system, and supply tracking system as distinct systems. In some embodiments, however, one or more of the task management system, work force management system, and supply tracking system may be implemented partially or fully through the OSA control system. Additionally or alternatively, one or more of the task management system, work force management system, and supply tracking system may be implemented through a central system, such as a central system of a retail chain. Some embodiments may further include one or more databases 122 that store information such as, but not limited to, customer profile information, product information, inventory information, sales information, work force allocation, work force predictions, task allocation information, task predictions, and the like.

In some embodiments, the OSA control system 104 receives forecasted and/or actual data directly or indirectly from one or more of the task management system 106, the work force management system 108, point-of-sale system 110 and supply tracking system 116, remote systems (central control, a retail chain headquarter, a product management system or other such source) to be used in forecasting OSA at the multiple shopping facilities 102. Based on the forecasted OSA, the OSA control system can further determine whether to make adjustments in attempts to enhance OSA and/or achieve a desire OSA.

As introduced above, the actual OSA at the shopping facilities are greatly impacted by the work tasks that are to be performed by the work force and the availability of the work force. The task management system 106 can be configured to schedule, receive and/or predict tasks that are to be performed by the work force and the extent (size, complexity, etc.) of the tasks. Tasks may be determined based in whole or typically in part on sales information provided by the point-of-sale system 110 and inventory distribution based on information from the supply tracking system 116. Further tasks are typically assigned, such as but not limited to price changing tasks, changes to product placement, and the like. Still further tasks correspond to the maintenance of the shopping facility as well as the support of customers (e.g., workers operating the point-of-sale units 112, customer service, workers stocking shelves, workers distributing and/or binning product deliveries, workers picking products to be stocked on shelves, and other such support tasks). Many tasks are interdependent in that the occurrence or predicted need of workers performing one task result in the need to complete a corresponding task. For example, the delivery of products to a shopping facility triggers a task to unload the products. The unloading often triggers binning tasks and distribution to a back storage area. Binning tasks often trigger restocking or re-shelving tasks to move the products to the sales floor. Further, the restocking of the shelves often corresponds to an increase in sales or maintains a level of sales, which causes point-of-sale tasks.

Again, in many instances tasks are assigned to the shopping facilities. For example, a regional or corporate office may decide to implement a price change of one or more products. Accordingly, the office will issue one or more tasks to the shopping facilities instructing that price changes be implemented for the one or more products. This results, at least in part, in one or more workers having to obtain the correct pricing information and labeling, go to the sales floor and modify the pricing information presented to customers on the sales floor for each of the one or more products, and may further include adjusting pricing formation elsewhere, such as in the point-of-sale system. Further, the office may issue one or more modular change tasks that include the movement and/or removal of one or more products from a modular or other such product storage unit (e.g., shelves, bins, etc.). This may further include the disassembly of a modular and the reassembly of a different or differently configured modular. Once modified and/or freed up, products have to be placed back onto the modular or other such product support unit. These modular changes can be relatively labor intensive and can divert work force and/or be a drain on the work force resources available to perform stocking tasks in attempts to maintain and/or achieve an OSA goal.

The work force management system utilizes the assigned and/or predicted tasks in determining and/or predicting work force at one or more of the shopping facilities corresponding to the predicted amounts of time for the work force to complete the tasks. This can be based on assigned work force allocation, based on historic information (e.g., work hours to complete one or more similar tasks in the past), and other such information. For example, the work force management system identifies one or more previously performed tasks that are the same as or similar to the scheduled task, and identifies a corresponding work force and amount of time worked by the work force to complete the task or tasks (e.g., average work force and average amount of time for multiple tasks), and schedules a work force and scheduled amount of work time consistent with and/or the same as the historic information. Further the work force management system can determine an available work force, and how to apply the available work force relative to the completion of assigned and/or predicted tasks. Typically, the work force management system applies priorities to different tasks in determining work force distribution.

The point-of-sale system 110 further provides information about the sales of products that is a direct indicator of the number of products being removed from the shelves. As products are removed from the shelves the OSA drops. The point-of-sale system further provides an indication of levels of OSA and can be an indication of predicted deliveries. As such, the OSA control system may further take into consideration sales information in predicting the OSA. Similarly, the task management system and the work force management system may utilize the point-of-sale information in predicting tasks and the work force that would be desirable to implement the tasks.

The supply tracking system receives and/or tracks product shipment requests from shopping facilities. Further, the supply tracking system tracks predicted, in route and/or actual product deliveries to the shopping facilities. This information again can be provided to the task management system to be used in assigning and/or scheduling tasks, and to the work force management system in assigning workers to perform the tasks corresponding to the delivery of products. Furthermore, the OSA control system can receive the tracked product shipment information and can use this information in predicting OSA, in part based on the available work force and/or redistribution of work force available.

Additionally, in some embodiments at least one database 122 may be accessible to the OSA control system. Such databases may be integrated into the OSA control system or separate from it. The databases may be at the location of one or more of the shopping facilities or remote from the shopping facilities. Regardless of location, the one or more databases comprise memory to store and organize certain data for use by at least the OSA control system 104. In some embodiments, the at least one database 122 may store data pertaining to one or more of: OSA predictions, OSA goals, inventory information, product information, sales information, task allocation, task prediction, work force allocation, work force predictions, and so on.

FIG. 2 illustrates a simplified block diagram of an exemplary OSA control system 104, in accordance with some embodiments. The OSA control system is configured predict OSA across multiple shopping facilities, and in some implement changes to be made to work force allocation and/or task assignments in attempts to improve OSA and in some instances achieve or exceed an OSA goal. In this example, the OSA control system includes a control circuit 202, memory 204, and one or more input/output (I/O) interfaces 206. Still further, in some embodiments, the OSA control system includes and/or implements one or more of the task management system 106 and work force management system 108.

In some implementations, the OSA control system includes one or more user interfaces 208 configured to allow users to interact with the OSA control system. In some embodiments, the OSA control system and/or the control circuit 202 can be implemented through one or more servers and/or computers operated at, remote from or a combination of at and remote from one or more shopping facilities. Further, the plurality of computers and/or servers may be distributed over one or more communication networks (e.g., the communication network 120), and may be geographically distributed while still being communicatively coupled to cooperatively operate to perform the functions of the OSA control system. The OSA control system typically provides OSA control over multiple shopping facilities 102, which may include shopping facilities over one or more regions, and/or may be over an entire network or chain of shopping facilities. In other instances, however, the OSA control system may be utilized with a single shopping facility (e.g., such as a store location, shopping mall, retail campus, or the like).

The control circuit 202 of the OSA control system typically comprises one or more processors and/or microprocessors. The control circuit couples with and/or includes the memory 204. Generally, the memory 204 stores the operational code or one or more sets of instructions that are executed by the control circuit 202 and/or processor to implement the functionality of the OSA control system. In some embodiments, the memory 204 may also store some or all of particular data that may be needed in predicting OSA. In some implementations, the memory further stores code, instructions and corresponding data to allow the OSA control system to propose and/or implement modifications in attempts to achieve an OSA goal, predict and/or assign work forces, predict and/or modify tasks, or other such instructions, or combination of such instructions. Such data may be pre-stored in the memory or be received, for example, from a central server or chain center, work force management system, task management system, shopping facilities, other sources, or combinations of such sources.

It is understood that the control circuit may be implemented as one or more processor devices as are well known in the art. Further, the control circuit may be implemented through multiple processors dispersed over the communication network. Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 204 is shown as internal to the OSA control system; however, the memory 204 can be internal, external or a combination of internal and external memory. Additionally, the OSA control system may include a power supply (not shown) and/or it may receive power from an external source. In some instances, the control circuit 202 and the memory 204 may be integrated together, such as in a microcontroller, application specification integrated circuit, field programmable gate array or other such device, or may be separate devices coupled together. In some applications, the control circuit 202 comprises a fixed-purpose hard-wired platform or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein.

The one or more I/O interfaces 206 allow wired and/or wireless communication coupling of the OSA control system to external components, such as the task management system 106, the work force management system 108, point-of-sale system 110, supply tracking systems 116, customers' user interface units (e.g., smart phones, tablets, etc.), the databases 122, shopping facilities systems, distribution center systems, and other such components. Accordingly, the I/O interface 206 may include any known wired and/or wireless interfacing device, circuit and/or connecting device, such as but not limited to transceivers, receivers, transmitters, and the like. For example, in some implementations, the I/O interface 206 provides wireless communication in accordance with one or more wireless protocols (e.g., cellular, Wi-Fi, Bluetooth, radio frequency (RF), other such wireless communication, or combinations of such communications). In some embodiments, the I/O interface includes one or more transceivers configured to couple with and transmit and/or receive communications from over the distributed communication network 120.

One or more user interfaces 208 can be included in and/or couple with the OSA control system, and can include substantially any known input device, such one or more buttons, knobs, selectors, switches, keys, touch input surfaces and/or displays, etc. Additionally, the user interface may include one or more output display devices, such as lights, visual indicators, display screens, touch screen, etc. to convey information to a user, such as OSA predictions, OSA goals, product information, inventory information, sales information, scheduled tasks, predicted tasks, other such task management information, scheduled work force allocation, predicted work force allocation, and other work force information, status information, history information, and/or other such information. While FIG. 2 illustrates the various components being coupled together via a bus, it is understood that the various components may actually be coupled to the control circuit 202 and/or one or more other components directly.

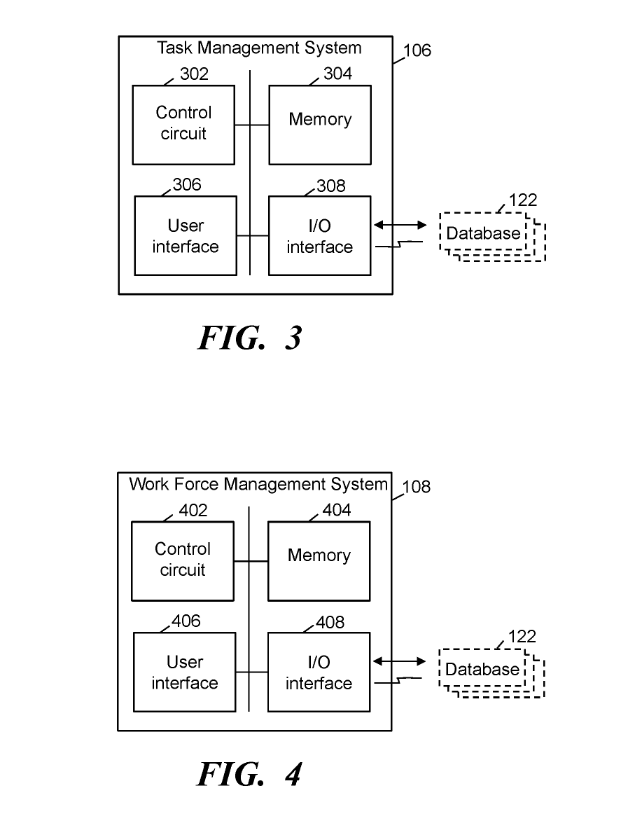

FIG. 3 illustrates a simplified block diagram of an exemplary task management system 106, in accordance with some embodiments. In this example, the task management system includes a control circuit 302, memory 304, and one or more input/output (I/O) interfaces 306. In some implementations, the task management system includes one or more user interfaces 308 configured to allow users to interact with the task management system.

The task management system and/or the control circuit 302 of the task management system can be implemented through one or more servers and/or computers operated at, remote from or a combination of at and remote from one or more shopping facilities. Further, the plurality of computers and/or servers may be distributed over one or more communication networks (e.g., the communication network 120), and may be geographically distributed while still being communicatively coupled to cooperatively operate to perform the functions of the task management system. Additionally or alternatively, the control circuit 302 may be implemented through one or more processors and/or microprocessors, which may be at a single location or dispersed over the communication network. The control circuit couples with and/or includes the memory 304. Generally, the memory 304 stores the operational code or one or more sets of instructions that are executed by the control circuit 302 and/or processor to implement the functionality of the task management system. In some embodiments, the memory may also store some or all of particular data that may be needed in predicting and/or scheduling predicted workloads corresponding to multiple different work tasks. In some implementations, the memory further stores code, instructions and corresponding data to allow the task management system to identify, predict and/or schedule workloads. Such data may be pre-stored in the memory or be received, for example, from a central server or chain center, work force management system, point-of-sale system, shopping facilities, other sources, or combinations of such sources.

The memory 304 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 304 is shown as internal to the task management system; however, the memory 304 can be internal, external or a combination of internal and external memory. Additionally, the task management system may include a power supply (not shown) and/or it may receive power from an external source. In some instances, the control circuit 302 and the memory 304 may be integrated together, such as in a microcontroller, application specification integrated circuit, field programmable gate array or other such device, or may be separate devices coupled together. In some applications, the control circuit 302 comprises a fixed-purpose hard-wired platform or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein.

The one or more I/O interfaces 306 allow wired and/or wireless communication coupling of the task management system to external components, such as the OSA control system 104, the work force management system 108, point-of-sale system 110, supply tracking systems 116, customers' user interface units (e.g., smart phones, tablets, etc.), the databases 122, shopping facilities systems, distribution center systems, and other such components. Accordingly, the I/O interface 306 may include any known wired and/or wireless interfacing device, circuit and/or connecting device, such as but not limited to transceivers, receivers, transmitters, and the like. For example, in some implementations, the I/O interface provides wireless communication in accordance with one or more wireless protocols (e.g., cellular, Wi-Fi, Bluetooth, radio frequency (RF), other such wireless communication, or combinations of such communications). In some embodiments, the I/O interface includes one or more transceivers configured to couple with and transmit and/or receive communications from over the distributed communication network 120.

In some implementations, the task management system further includes and/or couples with one or more user interfaces 308, which can include substantially any known input device, such one or more buttons, knobs, selectors, switches, keys, touch input surfaces and/or displays, etc. Additionally, the user interface may include one or more output display devices, such as lights, visual indicators, display screens, touch screen, etc. to convey information to a user, scheduled tasks, scheduled work force, scheduled workloads, predicted workloads, and/or other such information. While FIG. 3 illustrates the various components being coupled together via a bus, it is understood that the various components may actually be coupled to the control circuit 302 and/or one or more other components directly.

FIG. 4 illustrates a simplified block diagram of an exemplary work force management system 108, in accordance with some embodiments. In this example, similar to the task management system and/or the OSA control system, the work force management system includes a control circuit 402, memory 404, and one or more input/output (I/O) interfaces 406. In some applications, the work force management system further includes one or more user interfaces 408. Again, the work force management system is configured to, at least in part, plan predicted work forces at each of the shopping facilities corresponding to predicted amounts of time for the work force to complete work tasks at the shopping facilities.

The work force management system and/or the control circuit 402 can be implemented through one or more servers and/or computers operated at, remote from or a combination of at and remote from one or more shopping facilities. Further, the plurality of computers and/or servers may be distributed over one or more communication networks (e.g., the communication network 120), and may be geographically distributed while still being communicatively coupled to cooperatively operate to perform the functions of the work force management system. Additionally or alternatively, the control circuit 402 may be implemented through one or more processors and/or microprocessors, which may be at a single location or dispersed over the communication network. The control circuit couples with and/or includes the memory 404, which generally stores the operational code or one or more sets of instructions that are executed by the control circuit 402 and/or processor to implement the functionality of the work force management system. The memory may also store some or all of particular data that may be needed in predicting and/or scheduling the workforce corresponding to multiple different work tasks. In some implementations, the memory further stores code, instructions and corresponding data to allow the work force management system to identify, predict and/or schedule work forces at one or more shopping facilities. Such data may be pre-stored in the memory or be received, for example, from a central server or chain center, work force management system, point-of-sale system, shopping facilities, other sources, or combinations of such sources.

The memory 404 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 304 is shown as internal to the work force management system; however, the memory 404 can be internal, external or a combination of internal and external memory. Additionally, the work force management system may include a power supply (not shown) and/or it may receive power from an external source. In some instances, the control circuit 402 and the memory 404 may be integrated together, such as in a microcontroller, application specification integrated circuit, field programmable gate array or other such device, or may be separate devices coupled together. In some applications, the control circuit 402 comprises a fixed-purpose hard-wired platform or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein.

The one or more I/O interfaces 406 allow wired and/or wireless communication coupling of the work force management system to external components, such as the OSA control system 104, the task management system 106, point-of-sale system 110, supply tracking systems 116, customers' user interface units (e.g., smart phones, tablets, etc.), the databases 122, shopping facilities systems, distribution center systems, and other such components. Accordingly, the I/O interface 406 may include any known wired and/or wireless interfacing device, circuit and/or connecting device, such as but not limited to transceivers, receivers, transmitters, and the like. For example, in some implementations, the I/O interface provides wireless communication in accordance with one or more wireless protocols (e.g., cellular, Wi-Fi, Bluetooth, radio frequency (RF), other such wireless communication, or combinations of such communications). In some embodiments, the I/O interface includes one or more transceivers configured to couple with and transmit and/or receive communications from over the distributed communication network 120.

In some implementations, the work force management system further includes and/or couples with one or more user interfaces 408, which can include substantially any known input device, such one or more buttons, knobs, selectors, switches, keys, touch input surfaces and/or displays, etc. Additionally, the user interface may include one or more output display devices, such as lights, visual indicators, display screens, touch screen, etc. to convey information to a user, scheduled tasks, scheduled work force, scheduled workloads, predicted workloads, and/or other such information. While FIG. 4 illustrates the various components being coupled together via a bus, it is understood that the various components may actually be coupled to the control circuit 302 and/or one or more other components directly.

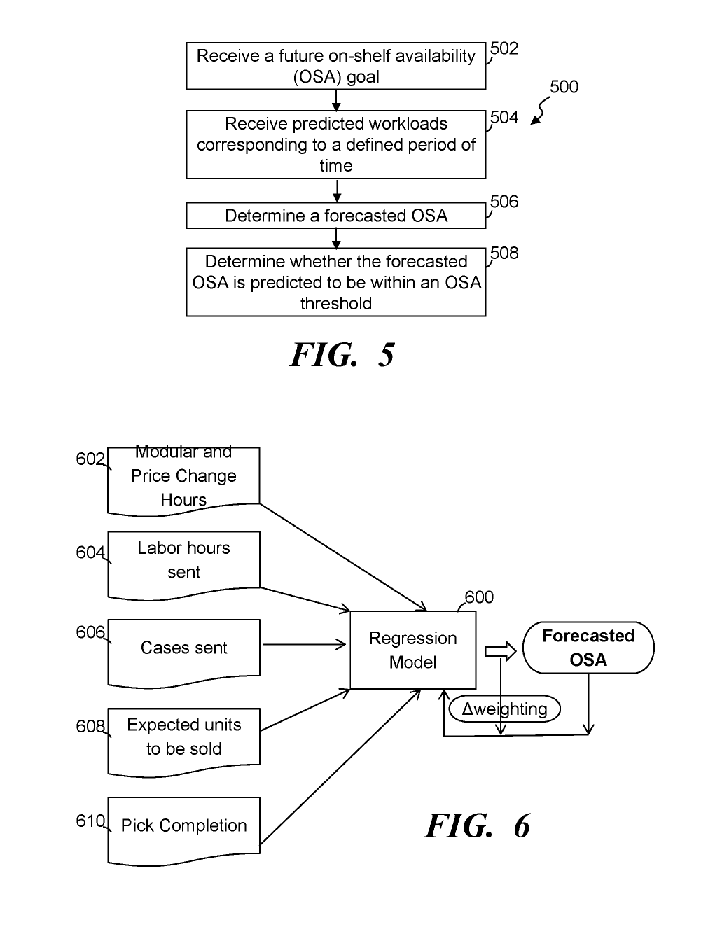

FIG. 5 shows a simplified flow diagram of an exemplary process 500 of forecasting and/or managing OSA, in accordance with some embodiments. In step 502, a future OSA goal is received that defines a desired OSA over a defined future period of time. Typically, the future OSA goal defines the OSA goal for multiple different products, and in some instances hundreds or more different products at the multiple shopping facilities. The OSA goal may be determined based on one or more parameters, such as but not limited to, historic sales, rate of sales, inventory shipments received, product shipment rates, historic OSA information, product pricing, product placement within a shopping facility, or other such information, and typically a combination and/or association between two or more of such parameters. For example, in some implementations the OSA goal may be determined based at least in part on a statistical analysis of historic sales relative to historic OSAs. In some embodiments the OSA goal is received from a central control, a retail chain headquarters, a product management system or other such source.

In step 504, one or more predicted workloads or task are received. The workloads, in some embodiments, correspond to the defined future period of time and are predicted to be assigned one or more of the shopping facilities. The work tasks are to be performed by a work force of employees at the shopping facilities. While completing the assigned tasks, the assigned work force to complete the task is unavailable to perform stocking, and as such these tasks that can affect an ability of each of the shopping facilities to meet a respective OSA goal. In some implementations the one or more predicted workloads are received from the task management system. The task management system, in some implementations, is configured to schedule predicted workloads corresponding multiple different work tasks intended to be performed at one or more of multiple shopping facilities. The task management system may receive a notification of one or more scheduled tasks to be performed at one or more shopping facilities, and based on the scheduled tasks predict the workload associated with each task. The predicted workload can be determined based on one or more factors. In some instances, the workload may be defined by a task scheduling system (e.g., central control, a retail chain headquarter, a product management system or other such source). In other instances, the task management system may evaluate the tasks (e.g., looking at historic data similar to and/or the same as the tasks to be performed, recommended workloads that may be provided with the task assignments, shopping facility efficiencies, and other such information), and/or parameters of the task (e.g., number of products to be moved and/or stocked, number of changes to a module, number of products that are to be moved, space availability, etc.) in predicting a workload. For example, the task management system may identify a similar previous task that was performed and obtain data identifying the corresponding workload to complete that previous task, and define the predicted workload to be consistent with the previous workload. Similarly, the task management system may modify that previous workload based on one or more parameters, such as differences in a number of products (e.g., adjust a workload proportionally based on a difference in a number of products), shopping facility efficiencies, and other such parameters. In some implementations, the workload may be defined as an amount of time predicted to complete a task, defined as a number of employee work hours to complete the task, other such designations, or a combination of different types of workload designations.

In step 506, a forecasted OSA is determined at the multiple shopping facilities for one or more products as a function of the predicted workloads. Some embodiments further take into consideration a planned work force availability at the shopping facilities to complete the work tasks at each of the shopping facilities in forecasting the OSA. For example, a central control, a retail chain headquarter, a product management system, or the like may specify a work force that is predicted to be available and/or predicted to be needed to perform assigned tasks, perform other work at the shopping facilities, and/or schedule employees to have the a desired planned work force to achieve a task within a predicted amount of time. Additionally or alternatively, the work force management system can plan predicted work forces at each of the shopping facilities corresponding to predicted amounts of time for the work force to complete work tasks at the shopping facilities. In some instances, the work force management system may evaluate a scheduled work force relative to tasks to be performed over the predefined period of time and determine whether the work force is predicted to complete the task or tasks within a prescribed threshold limit of time. The work force management system may schedule additional employees or reduce a number of employees scheduled based on predicted tasks and predicted workloads. In some embodiments, the work force management system utilizes historic data in planning a predicted work force. For example, the work force management system may access historic data to identify a work force that was scheduled for one or more tasks that are the same as or similar to assigned tasks and/or predicted to be assigned tasks, and relative to a duration of time it took for the work force to complete the tasks, and based on the time and work force, can plan a work force that is the same as or proportion to what was previously assigned. As a further example, if it is predicted the work load is twice a workload corresponding to a previous task, the work force management system may double a work force to complete the task in a similar amount of time, or apply some multiplier based on known differences between workloads.

In step 508, it is determined whether the forecasted OSA is predicted to be within an OSA threshold of the OSA goal as a function of the predicted workloads relative to planned work force availability at the shopping facilities. The OSA threshold may be specified by a central control, a retail chain headquarter, a product management system, a financial analysis group of a retail chain, or other such source. In some implementations, the forecasting of the OSA allows for a prediction of whether there is sufficient inventory on the shelves at the shopping facilities without having to have detailed inventory information.

Based on the determined forecasted OSA, some embodiments further identify adjustments in response to determining that the OSA goal is predicted not to be met. In some implementations, the control circuit of the OSA controller can identify, as a function of a difference between the forecasted OSA and the OSA goal, adjustments to be implemented relative to at least one of the workloads and the planned work force availability to be implemented at one or more of the shopping facilities when it is predicted the forecasted OSA is not within the OSA threshold of the OSA goal. For example, the scheduled work force can be adjusted to provide an adjusted available work force and/or the scheduled tasks can be modified (e.g., moved to a different time, decreased, increased, etc.) and/or canceled. Each of these adjustments cause a modification to an adjusted forecasted OSA. Accordingly, a recursive and/or regression process can be applied to implement adjustments to the workloads and the planned work force availability in attempting to achieve a forecasted OSA that is within the threshold of the OSA goal, with the intent that the forecasted OSA is achieved at the one or more shopping facilities. In some instances, the control circuit in identifying the adjustments to be implemented relative to at least one of the workloads and the planned work force availability further predictively identifies a portion of work and/or one or more tasks, allocated to occur during the defined period of time for which the OSA is being forecasted, that is to be rescheduled to occur during a different period of time outside of the defined period of time. This rescheduling of the work achieves a reduction in the workload allocated to the shopping facilities during the defined period of time. Accordingly, an updated or adjusted forecasted OSA, determined based on the reduced allocated workload, may then be determined that is predicted to be within the OSA threshold of the OSA goal, and/or further adjustments can be identified.

As described above, some embodiments, in forecasting the OSA, apply one or more factors or metrics, including the predicted workloads relative to the planned work force available. Other factors can correspond to tasks assigned (e.g., assigned modular change tasks, assigned price changing tasks, stocking tasks, product delivery intake tasks, sales tasks, maintenance tasks, other such tasks, or a combination of two or more of such tasks), assigned and/or predicted workloads and/or work hours corresponding to one or more tasks and/or associated with operation of the shopping facilities, predicted and/or actual sales, predicted and/or actual product deliveries to shopping facilities, shopping facility efficiencies, or other such factors or metrics, and typically a combination of such factors.

In some implementations, for example, the forecasted OSA is determined as a function of work load (e.g., hours of employee work) to perform assigned and/or predicted modular change tasks at shopping facilities, work load (e.g., hours of employee work) to perform assigned and/or predicted price changing tasks at shopping facilities, predicted and/or assigned workloads (e.g., hours of employee work) assigned to shopping facilities, workloads predicted to be needed at shopping facilities to stock cases of products scheduled to be delivered and/or already delivered to the shopping facilities, work load associated with forecasted items or units predicted to sell at the one or more shopping facilities during a defined period of time (e.g., a given day, a given multiple days, a given week, etc.), hours allocated for employees to perform various day-to-day tasks and/or activities at the one or more shopping facilities (e.g., tasks such as but not limited to picking items from a back room, front-end checkouts or sales, bin audits, counting items, and other such tasks, which may be dependent on and/or driven by other factors such as forecasted sales, product shipments received, and the like), and other such factors.

For example, some embodiments in forecasting the OSA apply the following OSA forecasting model:

Forecasted OSA=f(modular+price change hours)+f(hours sent)+f(cases sent)+f(units to be sold),

where: f(modular+price change hours) includes one or both of an anticipated modular change factor and a price change factor that include a workload predicted to perform modular change tasks (assigned and predicted to be assigned) and to perform price change tasks (assigned and/or predicted to be assigned) at one or more shopping facilities during a defined period of time; f(hours sent) is a predicted workload and hours sent factor and includes hours allocated for employees to perform various tasks (e.g., day-to-day tasks to operate the shopping facilities) at the one or more shopping facilities over the defined period of time; f(cases sent) is an anticipated product delivery or cases sent factor that includes an amount of inventory (which may be defined by individual products, by cases, or other value) that are sent to shopping facilities to meet the expected sales, and/or is defined as the work load associated with employees to work these cases when they arrive at the shopping facilities (e.g., removing from trucks, stock the shelves, binning products (e.g., overstock), etc.) during the defined prior of time; and f(units to be sold) is a predicted units to be sold factor that includes a forecasted number of units or products that are expecting to sell through the one or more shopping facilities during the defined period of time.

The modular and price change factor is typically a subset of the total hours allocated to shopping facilities. The modular and price change factor and/or hours may be budgeted by the task management system and/or other source (e.g., regional office, central office (e.g., based on marketing efforts, changes in season, and the like), etc.). Further, some embodiments do not include the modular and/or price change factor in the hours sent factor. Again, the hours sent factor typically is a work hours sent or otherwise allocated to shopping facilities to complete various activities. The hours sent are typically dependent at least in part on anticipated sales, work associated to provide for those sales (e.g., making sales), restocking shelf, receiving product shipments, and the like, and accordingly can be dependent on the units to be sold factor and the cases sent factor. In some implementations, the cases sent factor is converted to corresponding hours based on shopping facilities' predicted ability to receive and intake (e.g. stock, bin, back room storage, etc.) the received products. Similarly, the units to be sold factor can be defined as work hours performed by work force in order to sell the predicted units. Historical data is typically utilized in predicting at least units to be sold factor and the corresponding work hours, and is often used in predicting the cases sent factor to the shopping facilities in addition to already scheduled deliveries. Further, the cases sent factor typically is not a linear parameter. In many instances, as the amount of inventory delivered increases the work associated with working the delivered inventory increases by more than a factor of one. Some embodiments further take into consideration historical data in identifying and/or assigning workloads and/or work hours to be used in the cases sent factor.

Still further, some embodiments additionally take into consideration efficiencies at one or more shopping facilities in forecasting the OSA. For example, some embodiments further consider a pick completion factor defined by a ratio of completed pick tasks (i.e., instructions to employees to retrieve products and stock them on the shelves or other product support units on the sales floor to be available to customers) against a total number of pick tasks generated and/or requested. This is a historic evaluation and can be determined based on a per shopping facility, or based on multiple shopping facilities. Further, the historic evaluation may be limited based on time, based on a department of a shopping facility, or have other such focused parameters. In some instances, one or more systems may automatically create picks (automated/generated picks), such as an inventory system generating a pick for a first product in response to detecting a threshold number of the first product being sold through a point-of-sale system; the inventory and/or a shipping tracking system may automatically generate one or more picks in response to a shipment of one or more products being received; and other such system generated pick tasks.

Further, in some instances some employees may have the authority to created one or more picks (manual/requested picks). A factor of a number of picks actually completed, typically within a predefined time period, can be determined as actual numbers of items that were picked and moved and re-stocked on a shelf or other product support unit. For example, the actual picks completed factor can be actual numbers of items that were moved from an overstock location and re-stocked on the shelf, which may be reported by employees, detected based on optical scans of bar codes, and other such detections. This actual picks completed factor can be evaluated relative to a total number of picks assigned to one or more shopping facilities to determine a pick completion efficiency factor, which may be defined per shopping facility, or collectively defined for two or more shopping facilities (e.g., based on an area of a city, city, region, country, chain wide, globally, etc.). In some instances, picks are generated based on sales of products, and pick completions can be a good correlation with actual and/or predicted OSA.

Accordingly, the forecasting of OSA at one or more shopping facilities can take into consideration this pick completion efficiency factor. For example, some embodiments determine a forecasted OSA based on the follow OSA prediction model:

Forecasted OSA=f(Modular+price change hours)+f(Hours sent)+f(Cases sent)+f(Units to be sold)+f(Pick completion efficiency),

where: f(Pick completion efficiency) is the pick completion efficiency factor. In some embodiments, the pick completion efficiency factor is determined a function of the historic pick completion efficiency determined over time for the one or more shopping facilities. The use of the pick completion efficiency in forecasting the OSA provides a factor regarding how shopping facilities have been performing, compensates for an assumed optimal efficiency, and is projected to the future and in many implementations has improved the accuracy of the forecasting.

Accordingly, in some embodiments the control circuit of the OSA control system can further be configured to receive a completion efficiency factor that numerically defines, for the multiple shopping facilities, an efficiency of the work force at the shopping facilities to complete one or more assigned tasks and/or one or more assigned types of tasks. In some instances the efficiency may be a pick completion efficiency that defines an efficiency of the work force at one or more shopping facilities to move products to shelves on sales floors of the shopping facilities (e.g., ratio of completed picks to total picks assigned of a defined period of time). The control circuit can determine the forecasted OSA as the function of the pick completion efficiency, and the predicted workloads relative to planned work force availability. Further, in some instances, the pick completion efficiency is a function of historic assigned picks relative to historic completion the historic assigned picks.

Again, other factors are used in forecasting the OSA. Many embodiments determine a forecasted OSA based on modular & price change hours. The control circuit of the OSA control system 104 can receive an anticipated modular change factor (e.g., from a central or regional assigning source) and/or anticipated price change factor. Each of the modular change factor and the price change factor correspond to assigned work hours allocated to the work force for the anticipated time during the future defined period of time to complete intended modular changes within the shopping facilities and/or price changes of one or more different products within the shopping facilities.

Additionally or alternatively, in some embodiments, the forecasted OSA is further based on expected sales at the shopping facilities and/or an amount of products sent to shopping facilities. The control circuit can receive an expected number of units to be sold factor defining predicted numbers of one or more different products to be sold through the one or more shopping facilities during the future defined period of time. In many instances, the expected number of units to be sold factor is predicated based on past sales at one or more shopping facilities. Similarly, the control circuit may receive an anticipated product delivery factor defining predicted numbers of different products predicted and/or scheduled to be delivered to one or more shopping facilities during the future defined period of time, and which may be predicated, for example, based on past sales and past deliveries. The historic data used may consider current trends, previous years corresponding to the period of time for which the OSA is being predicted, seasons, past and/or forecasted weather, time of year, holidays, and other such factors.

Some embodiments apply a regression model in computing the forecasted OSA. The regression, in part, can include the adjustments to assigned and/or predicted factors that can be reapplied in determining an adjusted forecasted OSA in attempts to forecast an OSA that is within a threshold from an OSA goal, and/or identify modifications to workload and/or work force to achieve the desired OSA. Additionally or alternatively, some embodiments apply regression modeling in determining weightings and/or applying weightings to one or more factors used in calculating the forecasted OSA.

FIG. 6 illustrates a simplified block diagram of an exemplary regression modeling system 600 in accordance with some embodiments. Various factors can be considered by the regression modeling system. For example, in some implementations, the regression modeling receives modular and/or price change hours factors 602; hours sent factor 604; cases sent factor 606, units to be sold factor 608, and pick completion efficiency factor 610. Other and/or different factors may be considered in forecast OSA modeling. Typically, one or more well known regression analysis, modeling and/or techniques are employed (e.g., linear regression, ordinary least squares regression, nonparametric regression, other interpolation, and/or other such known techniques). The regression modeling can apply and/or modify the weightings through repeated iterations. The regression modeling system 600 can be part of or cooperate with the OSA control system, and can generate the forecasted OSA and/or provide feedback to the OSA control system in generating the forecasted OSA. In some instances, the regression can be repeated one or more times through repeated iterations while applying proposed modifications to one or more factors in attempts to identify modifications that may be applied to achieve a desired OSA.

In some embodiments, the factors are not equally applied in determining the forecasted OSA. Different factors have a different effect on the forecasted OSA, with some being of more importance in determining an accurate forecasted OSA than others. For example, the separation of the modular and/or price change factor from the hours sent factor allows each of these to be considered proportionally to their effects on predicted and/or actual OSA (e.g., based on a determination of how much pull from the hours sent factor is being used for other tasks (e.g., modular changes, price changes, and other such non-day to day tasks). Accordingly, many embodiments apply a weighting to the different factors in an attempt to normalize the impact of each factor. Some embodiments determine forecasted OSA in accordance with the following predicted OSA model:

Forecasted OSA=α(f(Modular+price change hours)+β(f(Actual hours sent)+μ(f(Inventory cases sent)+Ω(f(Units to be sold)+γ(f(Pick completion)),

where: α defines a weighting applied to the modular and price change hour factor, β defines a weighting applied to the hours allocated for work force factor, μ defines a weighting applied to the amount of inventory sent to the shopping facilities factor, Ω defines the weighting applied to the forecasted number of units or products that are expecting to be sold factor, and γ defines the weighting applied to the pick completion efficiency factor.

In some embodiments, one or more of the weightings are determined based on a regression method that includes, at least in part, an evaluation of historical data. Some applications use historic factor data (e.g., historic modular and price change hour factors, hours allocated for work force factors, amount of inventory sent to the shopping facilities factors, forecasted number of units or products that are expecting to be sold factors, and pick completion efficiency factors) and calculate, for a determined historic period of time, an expected OSA based on the historic factor data. The historic OSA is then evaluated relative to an actual OSA that was determined at the one or more shopping facilities over the historic period of time. The weightings can then be adjusted and the historic OSA be recalculated and again evaluated relative to the actual OSA. This can be repeated one or more times by continuing to adjust the weightings until the determined historic OSA is within at least a regression threshold of the actual OSA. This regression method can be repeated any number of times for any number of historic periods of time for which relevant data is available, while continuing fine tuning of the weightings through this regression.

As such, some embodiments apply data analysis using actual historic data and regressively adjusting the weightings and applying the modeling to determine how accurate the predictions would have been in order to obtain fine-tuned weightings. For example, actual historic data can be used over multiple different periods of time over a first year (e.g., 2013) in calculating a predicted OSA for those periods of time, which are compared to how accurate the forecasted OSA modeling would have been for similar periods of time for a subsequent year (e.g., 2014). The differences between the forecasted OSAs for the subsequent year can be used to regressively adjust weightings to achieve a desired and accurate modeling and weightings that can then be used in forecasting future OSAs. The modeling can continue to be regressively evaluated and adjusted over time by comparing over time forecasted OSAs to actual OSAs.

Again, some embodiments suggest and/or implement adjustments to work hours and/or assigned tasks in response to identifying that a predicted OSA is not expected to be within a threshold of a desired OSA. The adjustments can be determined based at least in part on historical changes in OSA based on corresponding historical work hours and/or assigned tasks. For example, when it is anticipated that the OSA goal is not expected to be met, the control circuit can evaluate individual forecasted factors relative to historical values of these factors (e.g., specific value for a given period of historic time, an average of values over multiple periods of time, or the like). It can be determined whether forecasted factors are more than a threshold difference than historic values (e.g., determining which one or more factors may be more than corresponding thresholds different from expected or typical). For example, one or more shopping facilities may have had price change hours doubled from one or more previous weeks and/or from a historically typical number of price change hours, which often indicates that work force will be diverted from putting product on the shelf in order to compensate for the increased price change hours that are scheduled to be performed. Based on this identification, an evaluation of reducing the price change hours scheduled to be performed and/or increasing workload hours. Additionally or alternatively, other factors can be evaluated to see whether adjustments can be made relative to the other factors to allow some or all of the scheduled price changes to be implemented while still predicting that the OSA goal will be achieved. Accordingly, the predicted OSA relative to the OSA goal can allow the OSA control system to determine a predicted amount of hours one or more shopping facilities need to add in additional labor and/or how much to reduce work load at the one or more shopping facilities in order to obtain a predicted OSA that is within a threshold of the desired OSA. In some embodiments, the OSA control system implements relevant adjustments. In other embodiments, the OSA control system recommends adjustments and/or generates one or more reports illustrating how certain adjustments will affect the predicted OSA, and allow an employee (e.g., regional manager, financial department of a retail chain, etc.) to select one or more of the recommendations and/or the adjustments to implement.

Based on the predict OSA, the OSA control system can identify and propose potential changes to effectively meet the OSA goal. The OSA control system can take advantage of historical data to look back and see when and/or how OAS goals were met. Additionally, the OSA control system typically continues to adjust the forecasting model used to predict the OSA with availability to evaluate adjustments implemented and how the predicted OSA based on those adjustments compared to actual OSA data. As such, the OSA controller can provide quantitative data to predict when one or more shopping facilities are likely to be able to meet OSA goals, and forecast when shopping facilities will not be able to meet the goal. Potential changes can be further quantitatively analyzed (e.g., add work force hours and/or change assigned tasks) in an effort to improve predicted OSA and hopefully meet the OSA goal. Accordingly, some embodiments receive a desired OSA goal, evaluate at least predicted work hours to determine whether the one or more shopping facilities are going to meet and/or be within a threshold of the OSA goal, and to propose and/or making adjustments to work hours and/or assigned work load when it is determined the one or more shopping facilities are predicted not to be within the OSA goal. The OSA control system, in some implementations, compares planned work force against planned work with an intent to try and achieve an OSA goal. This can include predicting and quantitatively determining how to best meet that goal and/or adjustments that might be made to meet the goal.

The predicted OSA can allow the OSA control system to determine, in part, whether an desired OSA is predicted to be achieved, whether there is a sufficient work force and/or allocated work hours, and how amount of work or tasks being assigned to shopping facilities are going to affect OSA. Further, some embodiments evaluate scheduled work and determine whether some work should be canceled and/or moved (e.g., can work be move from one week to another week) to accomplish the work while not adversely affecting the predicted OSA too much to cause the predicted OSA to drop below a threshold of a desired OSA), and/or in maximizing the OSA. Further, the work force can be modified to achieve the desired OSA.

The forecasting can be achieved in advance to provide a desired OSA before the OSA drops to levels that can greatly affect sales. Further, the forecasting not only provides an estimate of levels the stock at shopping facilities, it can further be used to determine how much excess or additional labor is assigned achieve an OSA goal. For example, if the predicted OSA is not sufficient (e.g., needed it to be 1% higher), the evaluation of historic information and/or input factors can allow the system to predict work hours and/or work force adjustments across the multiple shopping facilities (e.g., across a chain of shopping facilities) to achieve that OSA goal. Similarly, when sufficient additional hours cannot be implemented (e.g., increase a number of employees for one or more durations), the forecasted OSA and corresponding evaluations the input factors can be used to identify how work and/or task allocation might be redistributed (e.g., not perform as much new modular and/or price changes during a determined period of time).

In some embodiments, apparatuses, systems and methods are provided herein useful to improve OSA, identify the potential time and/or labor costs associated with trying to maintain a desired OSA, and/or identify potential modifications to shopping facility operation and/or assign tasks in attempting to achieve a desired OSA. In some embodiments, a system comprises: an OSA control system comprising: a control circuit; and a memory coupled to the control circuit and storing computer instructions that when executed by the control circuit cause the control circuit to: receive a future OSA goal defining a desired on-shelf availability over a defined future period of time of hundreds or more different products at the multiple shopping facilities; receive predicted workloads corresponding to the defined period of time and predicted to be assigned to the multiple shopping facilities; determine a forecasted OSA at the multiple shopping facilities as a function of the predicted workloads relative to planned work force availability at the shopping facilities to complete work tasks at each of the multiple shopping facilities; and determine whether the forecasted OSA is predicted to be within an OSA threshold of the OSA goal as a function of the predicted workloads relative to planned work force availability at the shopping facilities.

In some embodiments, a method comprises: by a control circuit of a product on-shelf availability control system: receiving a future on-shelf availability (OSA) goal defining a desired on-shelf availability over a defined future period of time of hundreds or more different products at multiple shopping facilities; receiving predicted workloads corresponding to the defined period of time and predicted to be scheduled for the multiple shopping facilities, wherein the predicted workloads correspond to multiple different work tasks intended to be performed at one or more of the shopping facilities, wherein the multiple different work tasks are to be performed by a work force of employees at the shopping facilities and affect an ability of each of the shopping facilities to meet a respective OSA goal; determining a forecasted OSA at the multiple shopping facilities as a function of the predicted workloads relative to planned work force availability at the shopping facilities to complete the work tasks at each of the shopping facilities; and determining whether the forecasted OSA is predicted to be within an OSA threshold of the OSA goal as a function of the predicted workloads relative to planned work force availability at the shopping facilities.

Still further, some embodiments provide systems to control product on-shelf availability at shopping facilities, comprising: means for receiving a future on-shelf availability (OSA) goal defining a desired on-shelf availability over a defined future period of time of hundreds or more different products at multiple shopping facilities; means for receiving predicted workloads corresponding to the defined period of time and predicted to be scheduled for the multiple shopping facilities, wherein the predicted workloads correspond to multiple different work tasks intended to be performed at one or more of the shopping facilities, wherein the multiple different work tasks are to be performed by a work force of employees at the shopping facilities and affect an ability of each of the shopping facilities to meet a respective OSA goal; means for determining a forecasted OSA at the multiple shopping facilities as a function of the predicted workloads relative to planned work force availability at the shopping facilities to complete the work tasks at each of the shopping facilities; and means for determining whether the forecasted OSA is predicted to be within an OSA threshold of the OSA goal as a function of the predicted workloads relative to planned work force availability at the shopping facilities.

Some embodiments provide a system to predict and/or control product on-shelf availability (OSA) at multiple shopping facilities, comprising: a point-of-sale system comprising point-of-sale units each configured to register a sale of one or more products; a supply tracking system configured to track product shipment requests and deliveries; a task management system configured to schedule predicted workloads corresponding multiple different work tasks intended to be performed at one or more of multiple shopping facilities, wherein the multiple different work tasks are to be performed by a work force of employees at the shopping facilities and affect an ability of each of the shopping facilities to meet a respective OSA goal; a work force management system configured to plan predicted work forces at each of the shopping facilities corresponding to predicted amounts of time for the work force to complete work tasks at the shopping facilities; and an OSA control system coupled with at least the supply tracking system and work force management system, wherein the OSA controls system comprises: a control circuit; and a memory coupled to the control circuit and storing computer instructions that when executed by the control circuit cause the control circuit to: receive a future OSA goal defining a desired on-shelf availability over a defined future period of time of hundreds or more different products at the multiple shopping facilities; receive, from the task management system, predicted workloads corresponding to the defined period of time and predicted to be assigned to the multiple shopping facilities; determine a forecasted OSA at the multiple shopping facilities as a function of the predicted workloads relative to the planned work force availability at the shopping facilities to complete the work tasks at each of the shopping facilities; and determine whether the forecasted OSA is predicted to be within an OSA threshold of the OSA goal as a function of the predicted workloads relative to planned work force availability at the shopping facilities.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system providing control over product on-shelf availability (OSA) at multiple shopping facilities, comprising:
an OSA control system comprising:
a control circuit; and
a memory coupled to the control circuit and storing computer instructions that when executed by the control circuit cause the control circuit to:
receive a future OSA goal defining a desired on-shelf availability over a defined future period of time of hundreds or more different products at the multiple shopping facilities;
receive predicted workloads corresponding to the defined period of time and predicted to be assigned to the multiple shopping facilities;
determine a forecasted OSA at the multiple shopping facilities as a function of the predicted workloads relative to planned work force availability at the shopping facilities to complete work tasks at each of the multiple shopping facilities; and
determine whether the forecasted OSA is predicted to be within an OSA threshold of the OSA goal as a function of the predicted workloads relative to the planned work force availability at the shopping facilities.

2. The system of claim 1, wherein the control circuit is further configured to identify, as a function of a difference between the forecasted OSA and the OSA goal, adjustments to be implemented relative to at least one of the workloads and the planned work force availability to be implemented at one or more of the shopping facilities when it is predicted the forecasted OSA is not within the OSA threshold of the OSA goal.

3. The system of claim 2, wherein the control circuit in identifying the adjustments to be implemented relative to at least one of the workloads and the planned work force availability is configured to predictively identify a portion of work, allocated to occur during the defined period of time, that is to be rescheduled to occur during a different period of time outside of the defined period of time and to achieve a reduction in the workload allocated to the shopping facilities during the defined period of time such that an updated forecasted OSA, determined based on the reduced allocated workload, is predicted to be within the OSA threshold of the OSA goal.

4. The system of claim 1, wherein the control circuit is further configured to:
receive a pick completion efficiency that numerically defines, for the multiple shopping facilities, an efficiency of the work force at the shopping facilities to complete assigned pick tasks to move products to shelves on sales floors of the multiple shopping facilities;
wherein control circuit determines the forecasted OSA as the function of the pick completion efficiency, and the predicted workloads relative to planned work force availability.

5. The system of claim 4, wherein the pick completion efficiency is determined as a function of historic assigned picks relative to historic completion of the historic assigned picks.

6. The system of claim 4, wherein the control circuit is further configured to:
receive an anticipated modular change factor and a price change factor each corresponding to assigned work hours allocated to the work force for anticipated time during the future defined period of time to complete intended modular changes within the shopping facilities and price changes of multiple different products within the shopping facilities;
wherein control circuit determines the forecasted OSA as the function of the pick completion efficiency, the modular change factor, the price change factor, and the predicted workloads relative to planned work force availability.

7. The system of claim 6, wherein the control circuit is further configured to:
receive a predicted units to be sold factor defining predicted numbers of different products to be sold through the shopping facilities during the future defined period of time and predicated based on past sales; and
receive an anticipated product delivery factor defining predicted numbers of different products to be delivered to the shopping facilities during the future defined period of time and predicated based on past sales and past deliveries;
wherein control circuit determines the forecasted OSA as the function of the predicted units to be sold factor, the anticipated product delivery factor, the pick completion efficiency, the modular change factor, the price change factor, and the predicted workloads relative to planned work force availability.

8. The system of claim 1, wherein the control circuit is further configured to:
receive an anticipated modular change factor and a price change factor each corresponding to assigned work hours allocated to the work force for anticipated time during the future defined period of time to complete intended modular changes within the shopping facilities and price changes of multiple different products within the shopping facilities;
wherein control circuit determines the forecasted OSA as the function of the modular change factor, the price change factor, and the predicted workloads relative to planned work force availability.

9. A method of providing control over product on-shelf availability at shopping facilities, comprising:
by a control circuit of a product on-shelf availability control system:
receiving a future on-shelf availability (OSA) goal defining a desired on-shelf availability over a defined future period of time of hundreds or more different products at multiple shopping facilities;
receiving predicted workloads corresponding to the defined period of time and predicted to be scheduled for the multiple shopping facilities, wherein the predicted workloads correspond to multiple different work tasks intended to be performed at one or more of the shopping facilities, wherein the multiple different work tasks are to be performed by a work force of employees at the shopping facilities and affect an ability of each of the shopping facilities to meet a respective OSA goal;
determining a forecasted OSA at the multiple shopping facilities as a function of the predicted workloads relative to planned work force availability at the shopping facilities to complete the work tasks at each of the multiple shopping facilities; and
determining whether the forecasted OSA is predicted to be within an OSA threshold of the OSA goal as a function of the predicted workloads relative to planned work force availability at the shopping facilities.

10. The method of claim 9, further comprising:
identifying, as a function of a difference between the forecasted OSA and the OSA goal, adjustments to be implemented relative to at least one of the workloads and the planned work force availability to be implemented at one or more of the shopping facilities when it is predicted the forecasted OSA is not within the OSA threshold of the OSA goal.

11. The method of claim 10, wherein the identifying the adjustments comprises predictively identifying a portion of work, allocated to occur during the defined period of time, that is to be rescheduled to occur during a different period of time outside of the defined period of time and to achieve a reduction in the workload allocated to the shopping facilities during the defined period of time such that an updated forecasted OSA, determined based on the reduced allocated workload, is predicted to be within the OSA threshold of the OSA goal.

12. The method of claim 9, further comprising:
receiving a pick completion efficiency that numerically defines, for the multiple shopping facilities, an efficiency of the work force at the shopping facilities to complete assigned pick tasks to move products to shelves on sales floors of the shopping facilities; and
wherein the determining the forecasted OSA comprises determining the forecasted OSA as the function of the pick completion efficiency, and the predicted workloads relative to planned work force availability.

13. The method of claim 12, further comprising:
determining the pick completion efficiency as a function of historic assigned picks relative to historic completion of the historic assigned picks.

14. The method of claim 12, further comprising:
receiving an anticipated modular change factor and a price change factor each corresponding to assigned work hours allocated to the work force for anticipated time during the future defined period of time to complete intended modular changes within the shopping facilities and price changes of multiple different products within the shopping facilities;
wherein the determining the forecasted OSA comprises determining the forecasted OSA as the function of the pick completion efficiency, the modular change factor, the price change factor, and the predicted workloads relative to planned work force availability.

15. The method of claim 14, further comprising:
receiving a predicted units to be sold factor defining predicted numbers of different products to be sold through the shopping facilities during the future defined period of time and predicated based on past sales; and
receiving an anticipated product delivery factor defining predicted numbers of different products to be delivered to the shopping facilities during the future defined period of time and predicated based on past sales and past deliveries;
wherein the determining the forecasted OSA comprises determining the forecasted OSA as the function of the predicted units to be sold factor, the anticipated product delivery factor, the pick completion efficiency, the modular change factor, the price change factor, and the predicted workloads relative to planned work force availability.

16. The method of claim 9, further comprising:
receiving an anticipated modular change factor and a price change factor each corresponding to assigned work hours allocated to the work force for anticipated time during the future defined period of time to complete intended modular changes within the shopping facilities and price changes of multiple different products within the shopping facilities;
wherein the determining the forecasted OSA comprises determining the forecasted OSA as the function of the modular change factor, the price change factor, and the predicted workloads relative to planned work force availability.

17. A system that provides control over product on-shelf availability at shopping facilities, comprising:
means for receiving a future on-shelf availability (OSA) goal defining a desired on-shelf availability over a defined future period of time of hundreds or more different products at multiple shopping facilities;
means for receiving predicted workloads corresponding to the defined period of time and predicted to be scheduled for the multiple shopping facilities, wherein the predicted workloads correspond to multiple different work tasks intended to be performed at one or more of the shopping facilities, wherein the multiple different work tasks are to be performed by a work force of employees at the shopping facilities and affect an ability of each of the shopping facilities to meet a respective OSA goal;
means for determining a forecasted OSA at the multiple shopping facilities as a function of the predicted workloads relative to planned work force availability at the shopping facilities to complete the work tasks at each of the multiple shopping facilities; and
means for determining whether the forecasted OSA is predicted to be within an OSA threshold of the OSA goal as a function of the predicted workloads relative to planned work force availability at the shopping facilities.
